(19) United States
(12) Patent Application Publication
(10) Pub. No.: US 2010/0097803 A1
(43) Pub. Date: Apr. 22, 2010

(54) Multiple Light Source Surface Packaging Structure

(76) Inventors: Ming-Chang WU, Tucheng City (TW); Chih-Chun Wen, Tucheng City (TW); Chih-Hung Wei, Tucheng City (TW)

Correspondence Address: FRENKEL & ASSOCIATES, 3975 UNIVERSITY DR., STE. 330, FAIRFAX, VA, 22030, US

(21) Appl. No.: 12/254,065

(22) Filed: Oct. 20, 2008

(51) Int. Cl. F21V 5/04

(52) U.S. Cl. 362/244

(57) ABSTRACT

The preferred embodiment the invention proposes pertains to a light source system structure, claimticularly referring to a multiple light-source source packaging structure, which is comprised of a surface wrapped with a multiple number of packagers, and inside the packagers is a placement space, and the surface of the packager is of a smooth surface; a micro-Fresnel lens unit, which is mounted in the placement space, and the micro-Fresnel lens unit is comprised of a multiple number of encircling micro-Fresnel lenses, with a concave slot located at the center of the encircling micro-Fresnel lens unit and a light source mounted beneath the concave slot, where the light created from the light source can be deflected and projected through the micro-Fresnel lens unit, through which to further control the angle of each light beam, together with a circuit control switch linked to the light source to further control the distance of light projection from the multiple number of packagers, enabling the distance of projection to be controlled by the varied micro-Fresnel lens unit within the packager.

### FIELD OF THE INVENTION

The preferred embodiment the invention proposes pertains to a light source system structure, claimticularly referring to a multiple light source surface packaging structure.

### DESCRIPTION OF THE PRIOR ART

Given that when producing the light emitting diode packaging in the conventional manner, a majority of which tends to solder the LED chipset onto a substrate to connect to the power and generate the illumination. And as the conventional LED packaging tends to result in a reduced light concentration for how its light projection is in a large-angle projection, consequently a light-gathering lens is placed directly above the LED for protection to complete the LED packaging structure; however, there will be no further modification since the distance of the light projection is fixed.

As the foresaid prior technique of a single LED packaging structure that tends to create large-angle light illumination, and in an attempt to create a perfect twice-or-more refractive LED packaging to achieve varied light projection effects, using the conventional packaging techniques would invariably result in the problems of excessive bulkiness and a high cost. But unable to achieve the usage light concentration, and manipulate the light projection for use within a claimameter we need, rendering it a major deficiency in LED chipset packaging.

In light of which, by focusing on the deficiency of the prior techniques, the new configuration has presented a multiple light-source surface packaging structure, and attempts to resolve the deficiencies found in the conventional techniques.

### SUMMARY OF THE INVENTION

The main objective of the invention lies in offering a multiple light-source surface packaging structure by utilizing a micro-Fresnel lens unit, which is symmetrically encircled in the inside of the packager, where the micro-Fresnel lens unit is set to different angles to manipulate each light source, and a multiple micro-Fresnel lens units are adopted to create a number of varied light projections, through which to achieve the objective of manipulating the light projection to variable distances.

One other objective of the invention lies in offering a multiple light-source surface packaging structure, which pertains to connecting a circuit control switch, which is used to manipulate the light projected from the light source contained in different packagers, and the switch is used to manipulate the micro-Fresnel lens units mounted inside the different sets of packagers in a single or multiple light projections, and the variable light projections can be manipulated to project different light projections of varied distances.

One other objective of the invention lies in offering a multiple light-source surface packaging structure, which pertains to applying a matte finish to the surface, through which to achieve the objective of manipulating the light projection.

To achieve the foresaid objectives, the invention pertains to a light source system structure, claimticularly referring to a multiple light-source surface packing structure, which is comprised of a surface, and on it is a smooth surface, and beneath it are a multiple packagers; a concave slot, which is mounted onto the center of the packager; and beneath it is a placement space, which accommodates a light source to be mounted within the placement space; a multiple micro-Fresnel lens units, which are configured in a circular configuration, centering around the concave slot, and configured in a symmetrical sequence inside the placement space; and the micro-Fresnel lens units are set to a number of different angles that in turn achieve manipulating the claimameters of light projection; a circuit control switch, which is connected to the light source, that is used to control the activation and deactivation of the light source at the multiple packagers, enabling the distance of light projection be manipulated by varied light source.

Below offers a detailed description of a tangible implementation example, coordinated with illustrated drawing, which will enable to better understand the objective, technical content, characteristics and anticipated performance of the invention.

### BRIEF DESCRIPTION OF THE FIGURES

FIG. 1 depicts a three-dimensional drawing of the invention's multiple light-source surface packing structure.

FIG. 2 depicts an enlarged perspective drawing of the invention's multiple light-source surfaces packaging structure.

FIG. 3 depicts an enlarged perspective drawing of the invention's packager.

FIG. 4 depicts an enlarged perspective drawing of the invention's one other packager.

FIG. 5 depicts the drawing of another implementation of the invention's multiple light-source surface packaging structure.

### REPRESENTATIVE FIGURES DESIGNATED TO THE PRESENT INVENTION

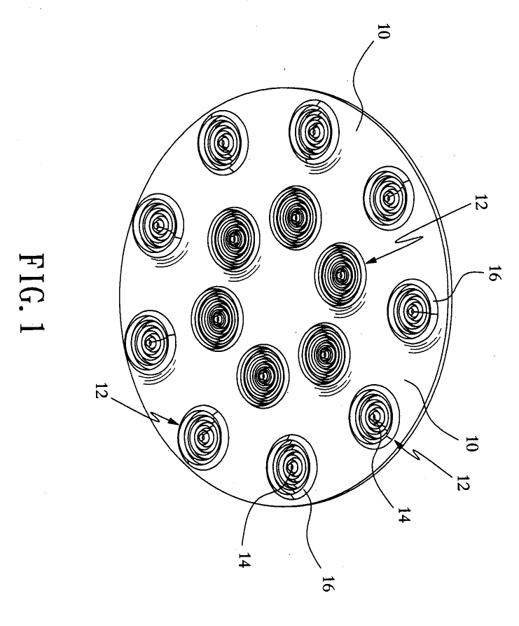

(I) The petition's designated drawing is: FIG. 1

(II) Description for the component symbols adopted in the illustrated drawing:
Flat surface 10
Packager 12
Concave slot 14
Micro-Fresnel lens unit 16

### DESCRIPTION OF SYMBOLS FOR MAJOR ELEMENTS

Flat surface 10
Packager 12
Placement space 121
Concave slot 14
Micro-Fresnel lens unit 16

### DESCRIPTION OF THE PREFERRED EMBODIMENTS

To avail the review panel to concisely understand the content of the invention's other characteristics and advantages and to highlight its anticipated performance, a description of the invention, coordinated with illustrated drawing, is provided as follows:

Methods for altering the direction of light encompass deflection, surface reflection, and full inner reflection. The conventional approach has largely taken to deflection and reflection. While the conventional lenses often create stray flare due to a narrowed light focus. In spite the optical theory of the Fresnel lens has been developed more than a century, it is not until recently that over-stacking Fresnel lenses have begun to emerge, helping to solve the disturbance of color contraction using single Fresnel lens, and at the same time greatly reduce the number and thickness of non-spherical lenses, thus effectively reducing the system weight and bulk.

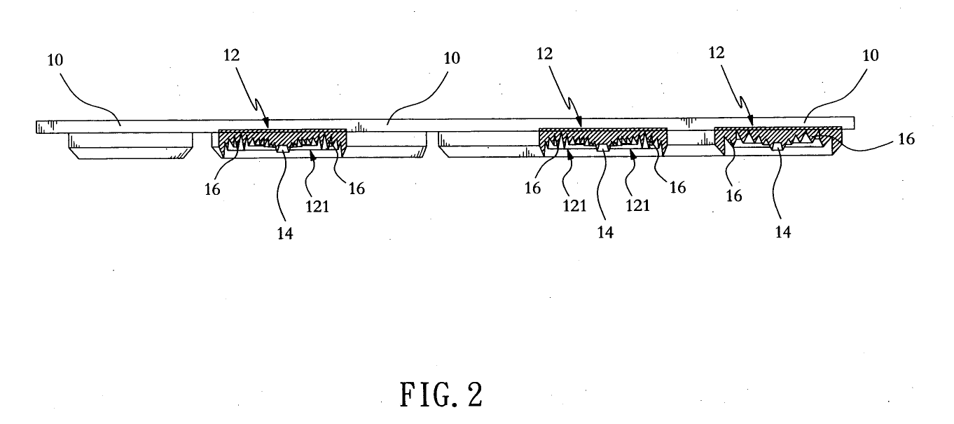

Please refer to FIG. 1 that depicts a three-dimensional drawing of the invention's multiple light-source surface packaging structure and FIG. 2 that depicts a perspective drawing of the invention's multiple light-source surface packaging structure; as depicted in the drawings, a flat surface 10, which has a smooth and light-emitting surface on it 10, and beneath the surface 10 are multiple packagers 12 of varied configurations mounted, and in the packager 12 contains a placement space 121; a concave slot 14 mounted in the center of the placement space 121 inside the packager 10, and beneath the concave 14 is a placement space 121 for packaging and mounting the light source, where the light source can either be a general light bulb or a light emitting diode (LED). Also, a multiple micro-Fresnel lens units 16 are placed in a circular configuration, centering around the concave slot 14, mounted in a sequential, symmetrical manner inside the placement space 121; the micro-Fresnel lens unit 16 is comprised of a multiple micro-Fresnel lenses, where the micro-Fresnel lens unit 16 can either be a flat lens, concave lens, convex lens or a concave/convex lens, and a combination of varied micro-Fresnel lens units 16 are coordinated according to the distance of the light source projection angle by deploying a multiple number of micro-Fresnel lens units to create an array of light projects to achieve the objective for manipulating the distance of projection from the light source.

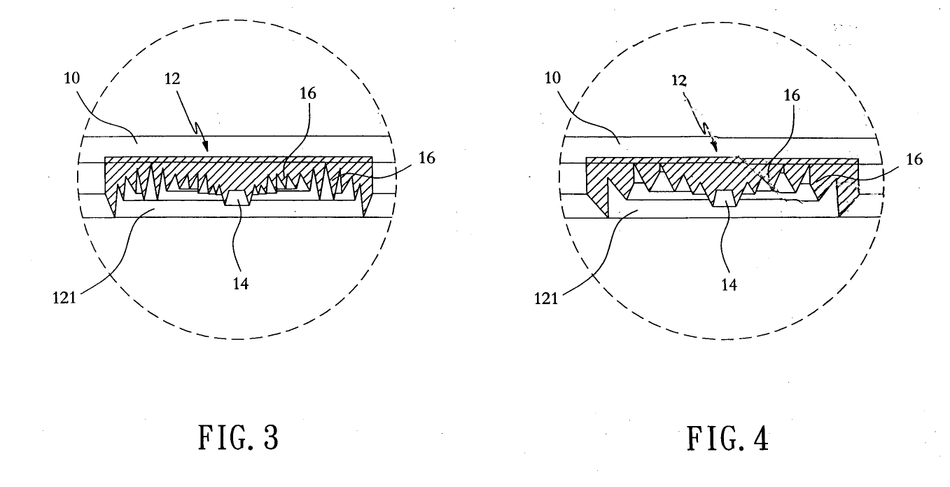

Please also refer to FIG. 3 that depicts an enlarged dissection drawing of the invention's packager and FIG. 4 that depicts an enlarged dissection drawing of yet another of the invention's packager, in which the micro-Fresnel lens units 16 are mounted in a number of different angles, hence derive the packagers 12 of varied structures, where through the deflection of the micro-Fresnel lens units 16, the angle of each light projection can be manipulated by reducing the halo created in light diffusion and the light diminishing phenomenon; therefore, the micro-Fresnel lens units set to different angles can be precisely manipulated to an angle of light diffusion, hence to achieve manipulating the range of distance in light projection. By utilizing a circuit control switch (not shown in the sketches, connected to the light source contained in different packagers 12, when in need of creating a longer distance light projection, the circuit control switch is used to convey the power to the inside of the packager designated for a longer light projection by utilizing the deflection of the micro-Fresnel lens unit 16 to diffuse the light via the surface 10, effectively gathering and diffusion the light source. When we need a shorter distance of light projection, the circuit control switch is used to sever the power feeding to the packager designated for a longer distance of projection but revamping the power to the packagers designated for a shorter distance of projection, enabling the deflection of light through the micro-Fresnel lens unit 16 to diffuse via the surface 10, thus enabling a range of projection of a closer light source. By utilizing varied packagers 12 through the circuit control switch, connecting the light source coming from different packagers 12 that allow switching into one or many light projection patterns can create different light projection patterns of varied distances using the a combination of light projection patterns; furthermore, the invention also offers a matte finish on the flat surface 10 to achieve the objective of manipulating the light projection patterns, in which, the light source is of an LED chipset.

Comclaimed with the conventional method of requiring a mechanical means to alter the projection through mirrored surface that is inconvenient to use, the invention merely needs to switch around the different packagers 12 by sorting the light source through the packagers 12 in order to effectively manipulate the distance of the light projection, in which the switching can be achieved by incorporating an external circuit control switch to offer an optimal packaging structure catering to an era of thinner light source.

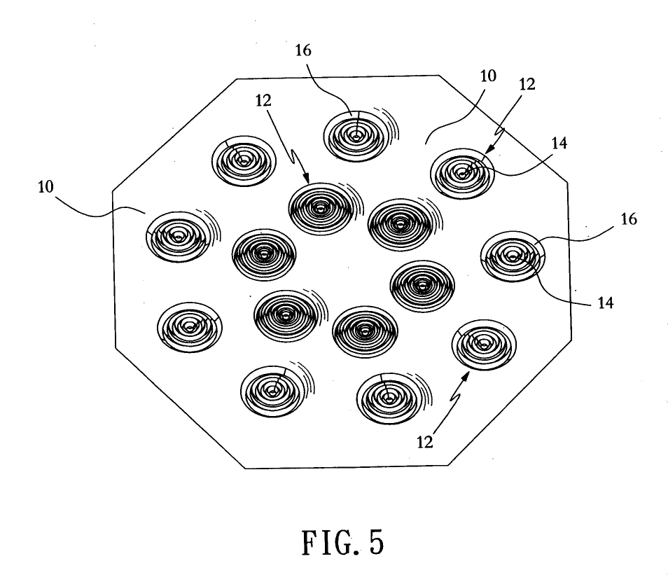

Please also refer to FIG. 5 that depicts another implementation example of the invention's multiple light-source surface packaging structure; as depicted in the drawing, the multiple packagers 12 are mounted beneath the flat surface 10, and the flat surface can be in a polygonal shape, rather than confined to a spherical shape, and that the configuration of the packagers 12 are largely determined by the configuration of the micro-Fresnel lens units 16 set to different angles.

In the case of a closer range of projection, the packagers contained in the micro-Fresnel lens units 16 are mounted on the inner circumference, whereas for a longer distance of projection, the packagers 12 contained in the micro-Fresnel lens units 16 are mounted on the outer circumference; similarly, for a longer distance of projection, the packagers 12 contained in the micro-Fresnel lens unit 16 are placed on the inner circumference, where in such a way, a circuit control switch can be incorporated to enable switching control that serves to switch around the different light source to create luminosity of varied distances, and greatly reduce the thickness of the entire lighting fixture, hence achieving the objective of bulk minimization, thus greatly enhancing its practicality.

By recapping the foregoing stated, the invention, revolutionary to the prior techniques, has indeed achieved the desired performance, and has not been thought of by those familiar with the technology; furthermore, nor has the invention ever been disclosed publicly prior to its petition, and that its progressiveness, practicality have ominously complied with the requisite conditions of patent filing, hence an invention petition is hereby filed beckoning your esteemed bureau to approve the invention's patent petition to motivate innovative invention, as the petitioner is grateful to the panel's review efforts.

As the foresaid implementation examples are provided merely to explain the invention's technical concept and characteristics, the objective of which has been to avail those familiar with the technique to understand the content of the invention and to implement it accordingly, hence none of which shall be taken to limit the patentable scope of the invention, and all variations or alterations derived from the spirit of the invention shall be covered under the patentable scope of the invention.

What is claimed is:

1. A multiple light-source surface packaging structure, which at least encompasses,
A flat surface, where on the surface is of a smooth surface, and beneath the surface are a multiple number of packagers;
A concave slot, which is located at the center of the packager, with a placement space in it that accommodates a light source device to be placed in it;
A multiple number of micro-Fresnel lenses, which are in a circular configuration, lined centering around the spherical concave slot and configured symmetrically around the placement space in a sequential order; and said micro-Fresnel lenses are arranged in different angles, which in turn generate different packagers to achieve manipulating the range of the light projection; and,
A circuit control switch, which is connected to the light source, and in turn controls the activation and deactivation of the multiple number of packagers, allowing the distance of project to be controlled by varied light source control.

2. Of the multiple light-source surface packaging structure as described in claim 1 of the scope of patent application, in which the light source is mounted at the lower half of the placement space, and the light source is projected out through the micro-Fresnel lens unit.

3. Of the multiple light-source surface packaging structure as described in claim 1 of the scope of patent application, in which the surface can be in a spherical shape.

4. Of the multiple light-source surface packaging structure as described in claim 1 of the scope of patent application, in which the surface can be in a polygonal shape.

5. Of the multiple light-source surface packaging structure as described in claim 1 of the scope of patent application, in which the micro-Fresnel lens unit is of a flat lens.

6. Of the multiple light-source surface packaging structure as described in claim 1 of the scope of patent application, in which the micro-Fresnel lens unit is of a concave lens.

7. Of the multiple light-source surface packaging structure as described in claim 1 of the scope of patent application, in which the micro-Fresnel lens unit is of a convex lens.

8. Of the multiple light-source surface packaging structure as described in claim 1 of the scope of patent application, in which the micro-Fresnel lens unit is of a concave/convex lens.

9. Of the multiple light-source surface packaging structure as described in claim 1 of the scope of patent application, in which the packager is amounted beneath the surface in a circular manner.

10. Of the multiple light-source surface packaging structure as described in claim 1 of the scope of patent application, in which the surface's smooth surface can be put through a matte finish.

11. Of the multiple light-source surface packaging structure as described in claim 1 of the scope of patent application, in which the sequence of configuration for the packagers is primarily made based on the configuration of the micro-Fresnel lens units set to varied angles.

12. Of the multiple light-source surface packaging structure as described in claim 11 of the scope of patent application, in which the packager containing the micro-Fresnel lens unit with a shorter distance of projection is mounted on the inner circumference, and the packager containing the micro-Fresnel lens unit with a longer distance of projection is mounted on the outer circumference.

13. Of the multiple light-source surface packaging structure as described in claim 11 of the scope of patent application, in which the packager containing the micro-Fresnel lens unit with a longer distance of projection is mounted on the inner circumference, and the packager containing the micro-Fresnel lens unit with a shorter distance of projection is mounted on the outer circumference.

14. Of the multiple light-source surface packaging structure as described in claim 1 of the scope of patent application, in which the light source is of an LED chipset.
